(19) United States
(12) Patent Application Publication
(10) Pub. No.: US 2015/0165595 A1
(43) Pub. Date: Jun. 18, 2015

(54) CLAMPING DEVICE

(71) Applicants: HONG FU JIN PRECISION INDUSTRY(ShenZhen) CO., LTD., Shenzhen (CN); HON HAI PRECISION INDUSTRY CO., LTD., New Taipei (TW)

(72) Inventors: DE-YI HUANG, Shenzhen (CN); FENG CHEN, Shenzhen (CN); HONG-JUN ZHU, Shenzhen (CN); HONG-JIAN MAO, Shenzhen (CN); BI-BO LUO, Shenzhen (CN)

(21) Appl. No.: 14/563,166

(22) Filed: Dec. 8, 2014

(30) Foreign Application Priority Data
Dec. 17, 2013 (CN) 201310690709.4

(51) Int. Cl. B25B 1/10

(52) U.S. Cl. CPC B25B 1/10

(57) ABSTRACT

A clamping device includes a base, a driver coupled to the base, a movable clamping jaw coupled to the driver and the sliding rail. The base includes a sliding rail, and a fixed clamping jaw coupled to the sliding rail. The movable clamping jaw is coupled to the driver and the sliding rail. The driver is configured to move the movable clamping jaw along the sliding rail towards the fixed clamping jaw. The movable clamping jaw includes a movable member having a main body. The main body defines two avoidance grooves at opposite side thereof. A side surface is formed at a side of each avoidance groove and spaced from the sliding rail.

### FIELD

The subject matter herein generally relates to clamping devices, and particularly to a vice.

### BACKGROUND

A clamping device, such as a vice, can be used to clamp a workpiece. When in a process of the workpiece, such as a cutting process, the workpiece can be secured on the clamping device.

### BRIEF DESCRIPTION OF THE DRAWINGS

Implementations of the present technology will now be described, by way of example only, with reference to the attached figures.

FIG. 1 is an isometric view of an embodiment of a clamping device including a movable member and a clamping member.

FIG. 2 is an exploded, isometric view of the clamping device of FIG. 1.

FIG. 3 is an enlarged, isometric view of the movable member the clamping device of FIG. 2.

FIG. 4 is a cross-sectional view of the clamping device of FIG. 1 taken along a line IV-IV.

FIG. 5 is an enlarged view of a circle V of the clamping device of FIG. 4.

FIG. 6 is an exploded, isometric view of the clamping member of the clamping device of FIG. 2.

FIG. 7 is a cross-sectional view of the clamping device of FIG. 1 taken along a line VII-VII.

FIG. 8 is similar to FIG. 7, but viewed in a state of use.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is in relation to a clamping device and can include a base, a driver coupled to the base, a movable clamping jaw coupled to the driver and the sliding rail. The base can include a sliding rail, and a fixed clamping jaw coupled to the sliding rail. The movable clamping jaw can be coupled to the driver and the sliding rail. The driver can be configured to move the movable clamping jaw along the sliding rail towards the fixed clamping jaw. The movable clamping jaw can include a movable member having a main body. The main body can define two avoidance grooves at opposite sides thereof. A side surface can be formed at a side of each avoidance groove and spaced from the sliding rail.

The present disclosure is in relation to a clamping device and can include a base, a driver, and a movable clamping jaw. The base can include a sliding rail having two first resisting surfaces facing each other, and a fixed clamping jaw coupled to the sliding rail. The sliding groove can be defined between the first resisting surfaces. The driver can be coupled to the base. The movable clamping jaw can be coupled to the driver. The movable clamping jaw can be slidably coupled to the sliding rail and positioned opposite to the fixed clamping jaw. The driver can be configured to move the movable clamping jaw along the sliding rail towards the fixed clamping jaw. The movable clamping jaw can include a movable member and a clamping member coving the movable member. The movable member can include a main body slidably received in the sliding groove. The main body can include two second resisting surface parallel to each other. Each second resisting surface can resist the corresponding first resisting surface. The main body can define two avoidance grooves at opposite sides thereof. A side surface can be formed at a side of each avoidance groove and spaced from the first resisting surface.

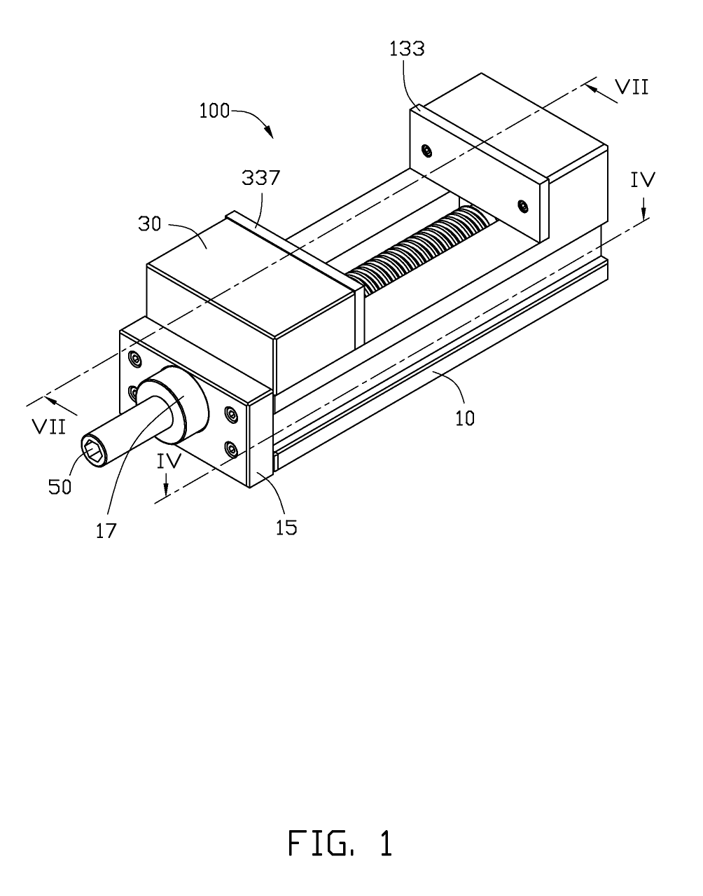

FIG. 1 illustrates an embodiment of a clamping device 100. The clamping device 100 can include a base 10, a movable clamping jaw 30, and a driver 50. The driver 50 can be coupled to the base 10. The movable clamping jaw 30 can be coupled to the driver 50 to slide relative to the base 10 driven by the driver 50. When in use, the base 10 can be put on a worktable. In the illustrated embodiment, the clamping device 100 can be a vice. The driver 50 can be a screw lead.

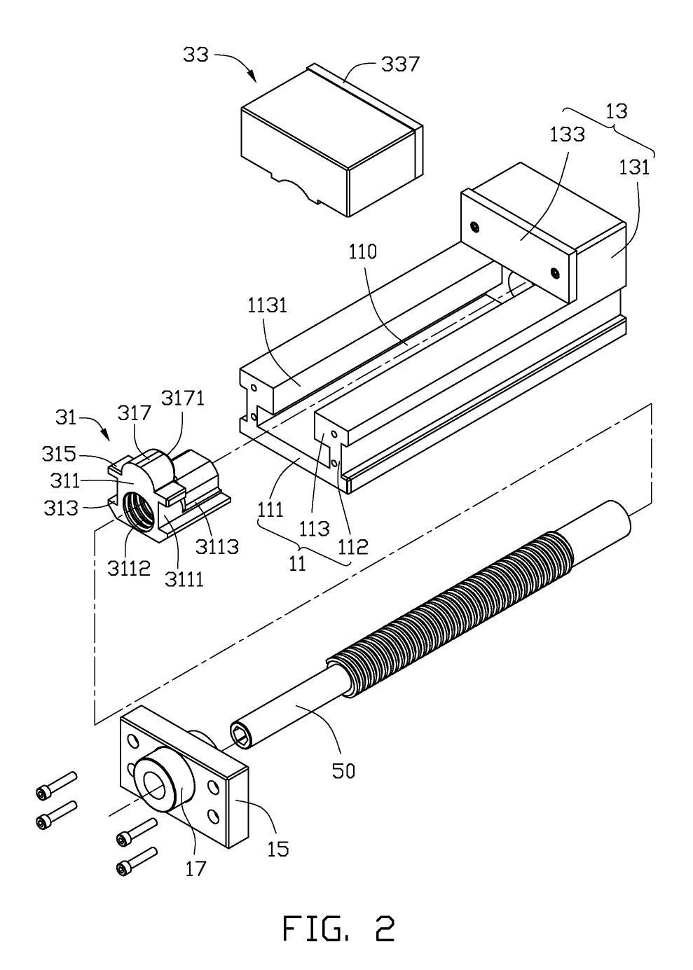

FIG. 2 shows that the base 10 can include a sliding rail 11, a fixed clamping jaw 13, a fixing plate 15, and a sleeve 17 coupled to the fixing plate 15. The sliding rail 11 can include a bottom wall 111, two sidewalls 112, and two top walls 113. The bottom wall 111 can be a substantially rectangular plate. The sidewalls 112 can extend from opposite edges of the bottom wall 111 towards a same side of the bottom wall 111. The sidewalls 112 can be substantially perpendicular to the bottom wall 111. Each top wall 113 can be coupled to one sidewall 112 and substantially perpendicular to the sidewall 112. The top walls 113 can be substantially in a same plane. Each top wall 113 can include a first resisting surface 1131 facing the other top wall 113. The bottom wall 111, the sidewalls 112, and the top walls 113 can define a sliding groove 110, cooperatively.

The fixed clamping jaw 13 can include a fixing portion 131 and a first clamping plate 133 coupled to a side of the fixing portion 131. The fixing portion 131 can be coupled to an end portion of the sliding rail 11 and positioned above the top walls 113. The fixing plate 15 can be coupled to another end portion of the sliding rail 11. The first clamping plate 133 can be coupled to a side of the fixing portion 131 adjacent to the fixing plate 15. The sleeve 17 can be substantially hollow cylindrical and inserted through the fixing plate 15.

The driver 50 can be rotatably inserted through the sleeve 17 and the fixed clamping jaw 13. In detail, a first end portion of the driver 50 can be rotatably inserted through the sleeve 17 and a second end portion of the driver 50 can be rotatably inserted through the fixing portion 131 of the fixed clamping jaw 13. The driver 50 can be received in the sliding groove 110. The movable clamping jaw 30 can be slidably coupled to the sliding rail 11 and positioned opposite to the fixed clamping jaw 13. The movable clamping jaw 30 can include a movable member 31 and a clamping member 33 coupled to the movable member 31. The clamping member 33 can be driven by the driver 50 to slide in the sliding groove 110 together with the movable member 31.

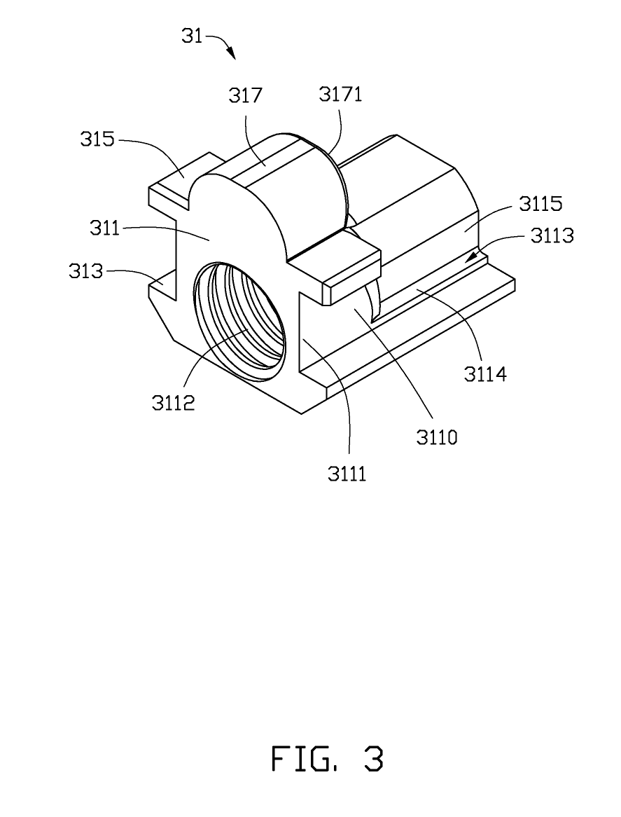

FIG. 3 shows that the movable member 31 can include a main body 311, two first resisting portion 313, two second resisting portion 315, and a third resisting portion 317. The main body 311 can be slidably received in the sliding groove 110. The main body 311 can be substantially columnar and include two second resisting surface 3111 opposite and parallel to each other. Each second resisting surface 3111 can resist one first resisting surface 1131. The main body 311 can define a thread hole 3112 along a longitudinal direction. The main body 311 can be sleeved on the driver 50 and thread with the driver 50. The driver 50 can be inserted through the thread hole 3112.

The main body 311 can further define two avoidance grooves 3113 at opposite sides of the main body 311. The avoidance grooves 3113 can run through an end of the main body 311 and adjacent to the second resisting surface 3111. In detail, a first end portion of each avoidance groove 3113 can run through the end of the man body 311 away from the second resisting surface 3111. A second end portion of the avoidance groove 3113 can extend to be adjacent to the second resisting surface 3111. A bottom surface 3114 can be formed at a bottom of each avoidance groove 3113. A side surface 3115 can be formed at a side of each avoidance groove 3113. Thus, the bottom surface 3114 and the side surface 3115 can define the avoidance groove 3113, corporately. The bottom surface 3114 can be horizontal and substantially perpendicular to the second resisting surface 3111. The side surface 3115 can be substantially parallel to the second resisting surface 3111. In the illustrated embodiment, the bottom surface 3114 and the side surface 3115 can be smooth coupled to each other.

The first resisting portions 313 can respectively extend outward from the main body 311 and symmetrically positioned at opposite side of the main body 311. The second resisting portions 315 can respectively extend outward from the main body 311 and be symmetrically positioned at opposite sides of the main body 311. In the illustrated embodiment, each second resisting portion 315 and the corresponding first resisting portion 313 of a same side can extend from the corresponding second resisting surface 3111 and can be spaced from each other. The second resisting portion 315 can be positioned at a top of the first resisting portion 313 and parallel to the first resisting portion 313. The second resisting portion 315 can be shorter than the first resisting portion 313. The first resisting portion 313 and the bottom surface 3114 can form a step and the bottom surface 3114 can be higher than the first resisting portion 313. The first resisting portion 313, the corresponding second resisting portion 315, and the second resisting surface 3111 can define a latching groove 3110, cooperatively.

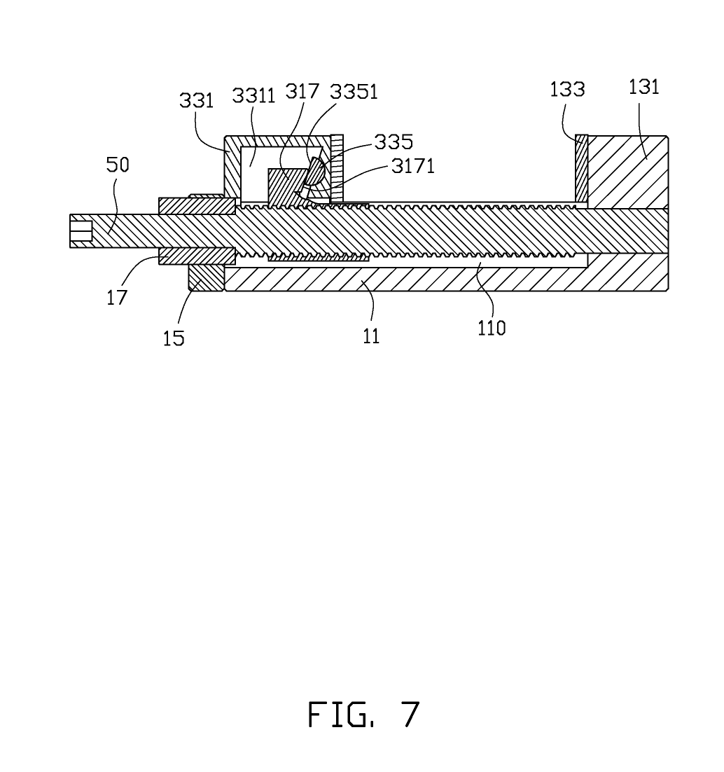

The third resisting portion 317 can extend upward from the main body 311 and positioned above the main body 311, the second resisting portions 315, the second resisting surfaces 3111, and the first resisting portions 313. An extending direction of the third resisting portion 317 can be substantially perpendicular to that of the second resisting portions 315. The third resisting portion 317 can be located between the second resisting portions 315. The third resisting portion 317 can include a first inclined surface 3171 (also shown in FIG. 7). The first inclined surface 3171 can be intersected with the driver 50 or a sliding direction of the movable member 31.

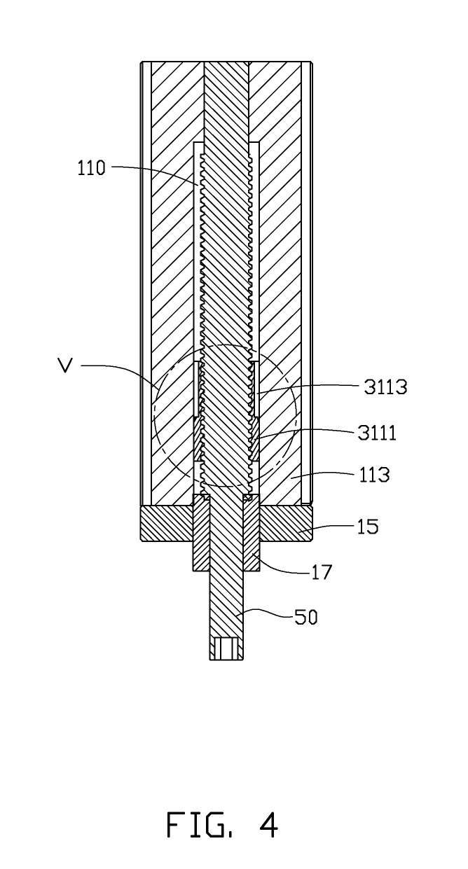

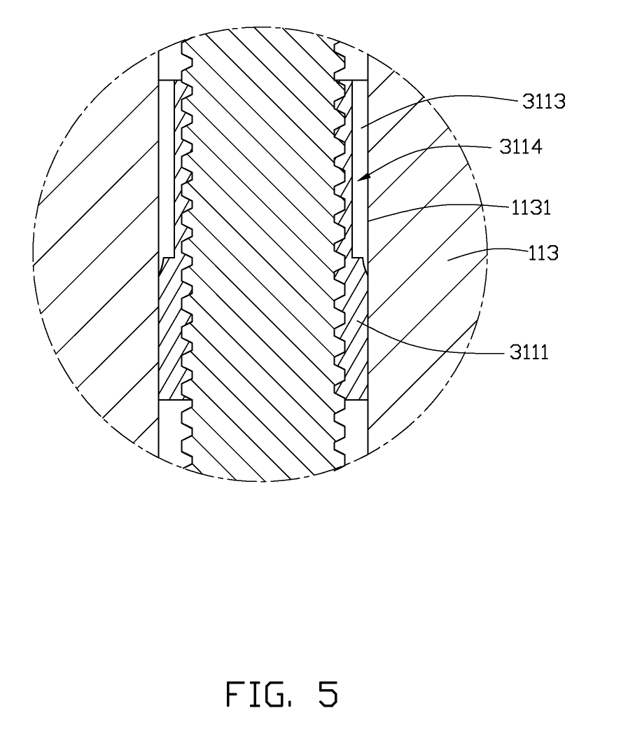

FIGS. 4 and 5 show that the side surface 3115 can be spaced from the first resisting surface 1131 when in assembled. The bottom surface 3114 can be positioned between the side surface 3115 and the first resisting surface 1131.

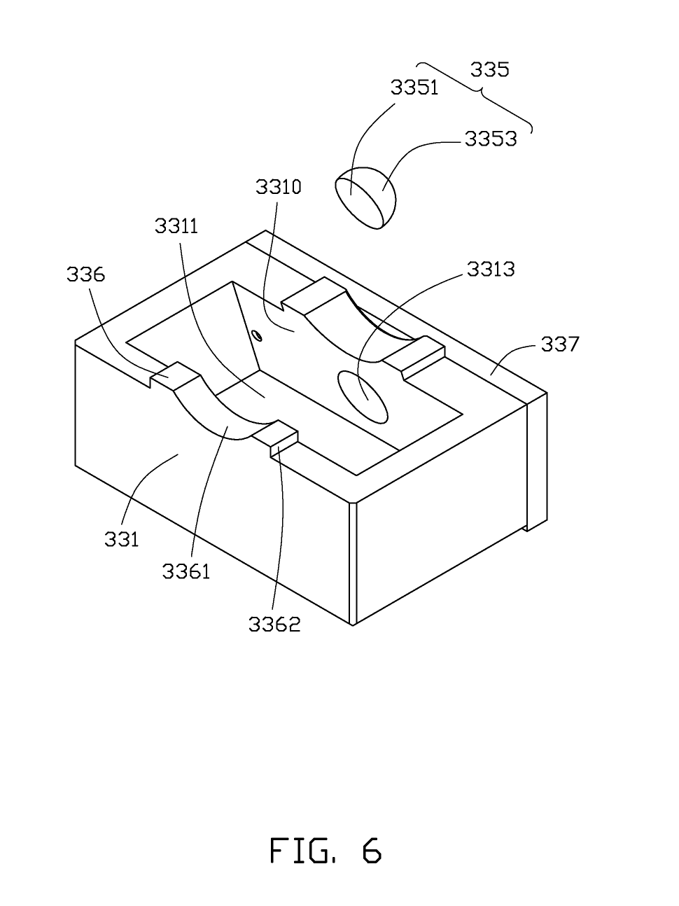

FIG. 6 shows that the clamping member 33 can be movably received in the sliding groove 110 and cover the movable member 31. The clamping member 33 can include a cover 331, an abut portion 335 coupled to the cover 331, two extending portion 336, and a second clamping plate 337. The cover 331 can be substantially a hollow cuboid and define a concave 3311. The concave 3311 can be configured for receiving the second resisting portions 315 and the third resisting portions 317 of the movable member 31. A second inclined surface 3310 can be formed on the cover 331 and received in the concave 3311. The second inclined surface 3310 can be a sidewall of the concave 3311 and parallel to the first inclined surface 3171. The second inclined surface 3310 can define a receiving groove 3313. The receiving groove 3313 can be substantially hemispherical and configured to received the abut portion 335.

The abut portion 335 can be substantially hemispherical and partially received in the receiving groove 3313. The abut portion 335 can include a third inclined surface 3351 and a curved surface 3353 coupled to the third inclined surface 3351. The third inclined surface 3351 can be exposed out from the receiving groove 3313 and parallel to the second inclined surface 3310. The extending portions 336 can extend from the cover 331 and positioned at opposite sides of the concave 3311. Each extending portion 336 can define an arc-shaped groove 3361. The extending portions 336 can be received in the sliding groove 110 and opposite end surfaces 3362 can respectively resist the first resisting surface 1131. The second clamping plate 337 can be coupled to the cover 331 and positioned at a side of the cover 331 adjacent to the first clamping plate 133. In the illustrated embodiment, an inner side wall of the extending portion 336 adjacent to the second inclined surface 3310 can be coplanar with the second inclined surface 3310.

In assembly, the first clamping plate 133 can be coupled to the fixing portion 131. The movable member 31 can be slidably coupled to the driver 50 and received in the sliding groove 110. Thus, the top walls 113 can be received in the latching groove 3110, respectively. The driver 50 can be threaded with the thread hole 3112. The first resisting surface 1131 can resist the second resisting surface 3111. The sleeve 17 can be coupled to the fixing plate 15 and then the fixing plate 15 can be coupled to the sliding rail 11. The abut portion 335 can interference fitted with the receiving groove 3313. The cover 331 coupled with the second clamping plate 337 can be slidably received in the sliding groove 110. The second resisting portions 315 and the third resisting portion 317 can be received in the concave 3311. The first inclined surface 3171 can resist the third inclined surface 3351. Opposite ends of each extending portion 336 can resist the top walls 113, respectively.

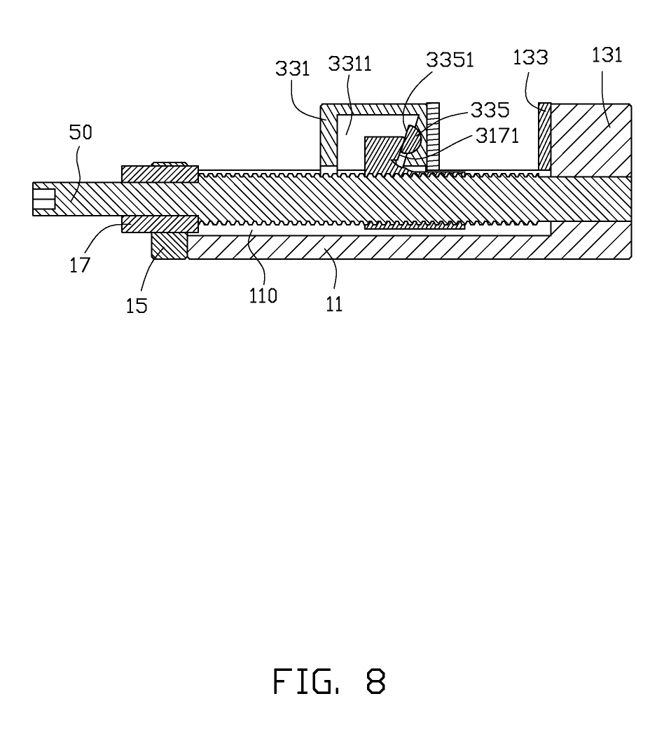

When in use, a workpiece can be positioned on the base 10 and positioned between the first clamping plate 133 and the second clamping plate 337. The first clamping plate 133 can resist the workpiece. The driver 50 can move the movable member 31 along a longitudinal direction of the sliding groove 110. The first inclined surface 3171 can resist the third inclined surface 3351 to push the clamping member 33 move toward the first clamping plate 133. Thus, the second clamping plate 337 can resist the workpiece, to enable the first clamping plate 133 and the second clamping plate 337 to clamping the workpiece, cooperatively. FIG. 7 shows that the movable clamping jaw 30 can be located at an end of the driver 50 away from the fixed clamping jaw 13. FIG. 8 shows that the movable jaw 30 can be located at a substantially middle portion of the driver 50 after moving along the driver 50.

The embodiments shown and described above are only examples. Many details are often found in the art such as the other features of a clamping device. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A clamping device comprising:
a base comprising:
a sliding rail having two first resisting surfaces facing each other, a sliding groove defined between the first resisting surfaces, and
a fixed clamping jaw coupled to the sliding rail;
a driver coupled to the base,
a movable clamping jaw coupled to the driver, the movable clamping jaw slidably coupled to the sliding rail and positioned opposite to the fixed clamping jaw, wherein the driver is configured to move the movable clamping jaw along the sliding rail towards the fixed clamping jaw,
the movable clamping jaw comprising:
a movable member comprising a main body slidably received in the sliding groove, the main body having two second resisting surfaces parallel to each other, each second resisting surface resisting the corresponding first resisting surface, the main body defining two avoidance grooves at opposite side thereof, a side surface formed at a side of each avoidance groove and spaced from the first resisting surface, and
a clamping member coving the movable member.

2. The clamping device of claim 1, wherein the sliding rail comprises a bottom wall, two sidewalls, and two top walls, the sidewalls extends from opposite edges of the bottom wall towards a same side of the bottom wall, each top wall is coupled to one sidewall and substantially perpendicular to the sidewall, the bottom wall, the sidewalls, and the top walls define the sliding groove, cooperatively, each first resisting surface is formed on the corresponding top wall.

3. The clamping device of claim 2, wherein the movable member further comprises:
two first resisting portions respectively extending outward from the main body and symmetrically positioned at opposite side of the main body, and
two second resisting portions respectively extending outward from the main body and symmetrically positioned at opposite side of the main body,
wherein each first resisting portion, the corresponding second resisting portion, and the corresponding second resisting surface define a latching groove, cooperatively, the top walls are received in the latching groove.

4. The clamping device of claim 3, wherein the movable member further comprises:
a third resisting portion extending upward from the main body and positioned between the second resisting portions, the third resisting portion comprises a first inclined surface intersected with a sliding direction of the movable member, the first inclined surface resists the clamping member to move the clamping member driven by the driver.

5. The clamping device of claim 4, wherein the clamping member comprises:
a cover defining a concave configured to receive the second resisting portions and the third resisting portion, a second inclined surface being formed on the cover and received in the concave, the second inclined surface defining a receiving groove of substantially hemispherical, and
an abut portion of substantially hemispherical and received in the receiving groove, wherein the abut portion comprises a third inclined surface and a curved surface, the third inclined surface is exposed out from the receiving groove and resists the first inclined surface.

6. The clamping device of claim 5, wherein the clamping member further comprises:
two extending portions extending from the cover and positioned at opposite sides of the concave, wherein the extending portions are received in the sliding groove, opposite end surfaces of each extending portion respectively resist the first resisting surfaces.

7. The clamping device of claim 6, wherein each extending portion defines an arc-shaped groove.

8. The clamping device of claim 6, wherein an inner side wall of the extending portion adjacent to the second inclined surface is coplanar with the second inclined surface.

9. The clamping device of claim 1, wherein the main body defines a thread hole along a longitudinal direction, the driver is inserted through the thread hole.

10. The clamping device of claim 1, wherein the fixed clamping jaw comprises:
a fixing portion, and
a first clamping plate coupled to a side of the fixing portion,
the clamping member further comprises a second clamping plate opposite to the first clamping plate, the driver is configured to move the second clamping plate towards the first clamping plate.

11. The clamping device of claim 1, wherein the base further comprises:
a fixing plate coupled to the sliding rail, and
a sleeve coupled to the fixing plate and inserted through the fixing plate, the driver is rotatably inserted through the sleeve.

12. A clamping device comprising:
a base comprising:
a sliding rail, and
a fixed clamping jaw coupled to the sliding rail;
a driver coupled to the base,
a movable clamping jaw couple to the driver and the sliding rail, wherein the driver is configured to move the movable clamping jaw along the sliding rail towards the fixed clamping jaw, the movable clamping jaw comprising:
a movable member comprising a main body, the main body defining two avoidance grooves at opposite side thereof, a side surface formed at a side of each avoidance groove and spaced from the sliding rail.

13. The clamping device of claim 12, wherein the sliding rail comprises a bottom wall, two sidewalls, and two top walls, the sidewalls extends from opposite edges of the bottom wall towards a same side of the bottom wall, each top wall is coupled to one sidewall and substantially perpendicular to the sidewall, the bottom wall, the sidewalls, and the top walls define a sliding groove, cooperatively.

14. The clamping device of claim 13, wherein the movable member further comprises:
two first resisting portions respectively extending outward from the main body and symmetrically positioned at opposite side of the main body, and
two second resisting portions respectively extending outward from the main body and symmetrically positioned at opposite side of the main body,
wherein each first resisting portion, the corresponding second resisting portion, and the corresponding second resisting surface define a latching groove, cooperatively, each top wall is received in the latching groove.

15. The clamping device of claim 14, wherein the movable clamping jaw further comprises a clamping member coupled to the movable member, the movable member further comprises a third resisting portion extending upward from the main body and positioned between the second resisting portions, the third resisting portion comprising a first inclined surface intersected with a sliding direction of the movable member.

16. The clamping device of claim 15, wherein the clamping member comprises:
a cover defining a concave configured to receive the second resisting portions and the third resisting portion, a second inclined surface is formed on the cover and received in the concave, the second inclined surface defining a receiving groove of substantially hemispherical, and
an abut portion of substantially hemispherical and received in the receiving groove, wherein the abut portion comprises a third inclined surface exposed out from the receiving groove and resists the first inclined surface.

17. The clamping device of claim 16, wherein the clamping member further comprises:
two extending portions extending from the cover and positioned at opposite sides of the concave, wherein the extending portions are received in the sliding groove and opposite end surfaces of each extending portion respectively resist the top walls.

18. The clamping device of claim 17, wherein each extending portion defines an arc-shaped groove.

19. The clamping device of claim 12, wherein the fixed clamping jaw comprises:
a fixing portion, and
a first clamping plate coupled to a side of the fixing portion,
a clamping member further comprising a second clamping plate opposite to the first clamping plate, the driver is configured to move the second clamping plate towards the first clamping plate.

20. The clamping device of claim 12, wherein the driver is a screw lead.
